(19) United States
(12) Patent Application Publication
(10) Pub. No.: US 2008/0256779 A1
(43) Pub. Date: Oct. 23, 2008

(54) HEMMING WORKING METHOD AND HEMMING WORKING DEVICE

(75) Inventors: Hidekazu Ryu, Hagagun (JP); Yoshiyuki Kinouchi, Hagagun (JP); Eisaku Hasegawa, Hagagun (JP); Manabu Takimoto, Hagagun (JP); Masaji Kojima, Hagagun (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/104,853

(22) Filed: Apr. 17, 2008

(30) Foreign Application Priority Data
Apr. 19, 2007 (JP) 2007-110664

(51) Int. Cl. B21D 25/04; B23P 11/00

(52) U.S. Cl. 29/505; 72/293

(57) ABSTRACT

A hemming working device is provided with: a jig body configured to support a first workpiece and a second workpiece which are overlapped; and a working drive portion configured to join the first workpiece and the second workpiece and perform a hemming on the first workpiece and the second workpiece. The jig body is provided with: a holding mechanism capable of holding the first workpiece and the second workpiece; and a backing member capable of being contacted with a portion of the first workpiece where hemming working is executed.

This application claims foreign priority from Japanese Patent Application No. 2007-110664 filed on Apr. 19, 2007, the entire contents of which are hereby incorporated by reference.

### BACKGROUND OF THE INVENTION

1. Field of the Invention

The present invention relates to a hemming working method and hemming working device for combining a plurality of workpieces with each other.

2. Background Art

For example, an edge portion of a workpiece such as a hood, a side panel or a door of an automobile is subjected to hemming work in which a flange portion formed out of a rising edge portion of the panel is bent inside the panel.

Concerning the above hemming working, the roller hemming working is executed in which a panel is positioned and held on a stationary metallic die and a flange of an edge portion of the panel is bent while a working roller is being pressed onto the flange. The metallic die hemming working is also executed in which a panel positioned and held is pinched between an upper and a lower metallic die and the flange is bent.

In the above roller hemming working or the metallic die hemming working (referred to as hemming working hereinafter), in general, a bending angle is so large that, in order to ensure the bending accuracy, a plurality of steps such as a preliminary bending (pre-hemming) or a finishing bending (primary hemming) is executed in the process of hemming work.

JP-A-2003-103325 discloses a hemming working device in which the hemming working is conducted on edge portions of two panels by a hemming roller and an idle roller which are arranged on both sides of a base so that both panels can be combined with each other.

In this connection, depending upon the type of a workpiece, in order to further enhance the combining strength of panels, in addition to the conjunction made by the hemming working, two panels are joined with each other by means of welding in some cases.

In this case, the hemming working is usually executed as follows. First, two panels, for example, an outer panel and inner panel of a door of an automobile are joined with each other by means of welding so that both panels can be fixed with each other. Next, after both the fixed panels have been conveyed to a hemming station, the hemming working is executed by a metallic die.

However, in the case where both panels are joined with each other by means of welding before the hemming working, the hemming working is executed under the condition that both panels are substantially completely fixed with each other. Accordingly, it is difficult for the entire workpiece to absorb deflection of the panel which is generated in the process of hemming working. Accordingly, strain appears in a portion, which has been subjected to the hemming working, after the completion of the hemming working. In this connection, in the first stage of the hemming working in which a flange raised from a panel edge portion by the angle of 90° is bent, the workpiece is pushed inside by a bending action of the flange. Therefore, an amount of deflection of the workpiece is bigger than that caused in the latter stage of the hemming working. Usually, a portion of the workpiece, which has been subjected to the hemming working, composes the appearance of a product. Therefore, the above deflection of the workpiece becomes a factor of deteriorating the appearance of the product. Accordingly, in order to enhance the product quality, it is important to prevent the generation of the deflection On the other hand, in the case where the workpieces are not joined with each other by means of welding, the panels are shifted from each other during the process of hemming working. As a result, there is a possibility that the working quality is deteriorated.

### SUMMARY OF THE INVENTION

One or more embodiments of the invention provide a hemming working method and a hemming working device capable of preventing the generation of deflection of a workpiece even in the case where panels are joined with each other when a plurality of panels are combined with each other by means of hemming working.

In accordance with one or more embodiments of the invention, a hemming working method of combining at least a first workpiece with a second workpiece is performed by: a joining step in which the first workpiece and the second workpiece are joined with each other; and a hemming step in which an edge portion of the first workpiece is bent during the joining step so as to pinch an edge portion of the second work by the edge portion of the first workpiece.

According to this method, in the step of joining in which the first and the second workpieces are joined with each other, for example, by means of welding, the hemming step, in which the edge portion of the first workpiece is bent, is carried out. Due to the foregoing, the workpiece can be effectively prevented from being shifted in the step of hemming. Further, when only one of the joining points of the workpiece is joined in the first stage of working in which an amount of deflection of the workpiece tends to be big, deflection of the workpiece, which is generated in the hemming step, can be effectively absorbed by the entire workpiece. Therefore, an amount of strain, which is generated after the completion of working, can be reduced. Further, when the joining step and the hemming step are simultaneously executed, in accordance with the progress of the hemming step, it becomes possible to gradually strongly join the workpiece corresponding to a state of the hemming step. Due to the foregoing, while deflection of the workpiece generated in the first stage of the hemming working is being suitably absorbed, the hemming working can be executed under the condition that the workpiece is substantially completely joined in the latter stage of the hemming working. Accordingly, it is possible to enhance quality of the hemming working.

In this case, the hemming step may be started and finished during a period from the first joining to the last joining in the joining step. Therefore, the hemming step can be finished under the condition that the first and the second workpieces are allowed to somewhat move. Accordingly, deflection generated in the workpiece in the hemming step can be more positively absorbed by the entire workpiece and strain of the workpiece generated after the completion of the hemming working can be more positively prevented. Therefore, the above constitution is preferable.

After at least the first workpiece has been held by a hemming roller to execute the hemming work and before the hemming roller starts rolling, the first workpiece and the second workpiece may be joined with each other. Due to the foregoing, the workpiece can be effectively prevented from being shifted while the hemming roller is rolling. Therefore, the above constitution is preferable.

After the hemming roller has finished rolling and before the hemming roller starts releasing a force given to the first and the second workpieces, the first and the second workpieces may be joined with each other. Due to the foregoing, a phenomenon of spring-back is generated in the workpiece and a shift generated between the first and the second workpieces can be effectively prevented. Therefore, the above constitution is preferable.

Moreover, in accordance with one or more embodiments of the invention, a hemming working device is provided with: a jig body for supporting a first workpiece and a second workpiece which are put on each other; and one or more working drive portions for joining and hemming the first and the second workpieces which are supported by the jig body. The jig body is provided with: a holding mechanism capable of holding the first and the second workpieces; and a backing member arranged so that it can be contacted with a portion of the first workpiece where hemming working is executed.

When the above device is used, the joining step and the hemming step can be executed for the workpiece by using the same jig body. Therefore, it is unnecessary to individually provide a jig and a working station for each step. Accordingly, with respect to the entire device, the space can be greatly saved and the equipment investment cost can be reduced. Further, since two steps are condensed with each other, the working efficiency can be enhanced. Furthermore, since it becomes unnecessary to execute a conveyance work of conveying the workpiece from the joining step to the hemming step, a shift and deflection of the workpiece caused by the conveyance work can be effectively prevented.

When the backing member is attached to the jig body so that it can float with respect to the jig body, even if a small error is made between a surface of the workpiece and a surface of the backing member, the workpiece is forcibly pressed to the backing member at the time of the hemming step. Therefore, deformation can be effectively prevented.

According to the hemming working method of one or more embodiments of the present invention, in the joining step of joining the first workpiece to the second workpiece, the hemming step, in which the edge portion of the first workpiece is bent, is executed. Due to the foregoing, the workpieces can be prevented from being shifted in the hemming step and further the workpieces can be prevented from being strained after the completion of the hemming working.

According to the hemming working device of one or more embodiments of the present invention, the joining step of joining the workpieces and the hemming step can be executed by using the same jig body. As a result, it becomes unnecessary to individually prepare a jig and a working station for each step. Accordingly, with respect to the entire device, the space can be greatly saved and the equipment investment cost can be reduced. Further, since two steps are condensed with each other, the working efficiency can be enhanced.

Other aspects and advantages of the invention will be apparent from the following description, the drawings and the claims.

### BRIEF DESCRIPTION OF THE DRAWINGS

FIG. 1 is a perspective view for explaining circumstances in which the hemming working is executed for an edge portion of a workpiece, which includes an outer panel and an inner panel, by a hemming working device of a first exemplary embodiment of the present invention.

FIG. 2 is a plan view for explaining the hemming working device shown in FIG. 1.

FIG. 3 is a partially cutaway perspective view of a front door of an automobile which is the workpiece shown in FIG. 1.

FIG. 4 is a substantial front view of a jig body shown in FIG. 1.

FIG. 5 is a schematic front view showing a state in which a workpiece is fixed to the jig body shown in FIG. 4.

FIG. 6A is a partially omitted sectional view taken on line VI-VI in FIG. 5.

FIG. 6B is a partially omitted sectional view showing a state in which a hemming roller and a guide roller are moved from positions in the state shown in FIG. 6A to positions of the finishing bending step.

FIG. 7 is a partially omitted exploded sectional perspective view for explaining an attaching structure of a floating supporting member for supporting a backing member provided in the jig body shown in FIG. 4.

FIG. 8 is a partially omitted sectional view taken on line VIII-VIII in FIG. 4.

FIG. 9 is a partially sectional perspective view taken on line IX-IX in FIG. 5 for explaining a state in which a preliminary bending step is executed for an edge portion of a workpiece by the hemming working tool shown in FIG. 1.

FIG. 10 is a flow chart showing a procedure of a hemming working method executed by the hemming working device shown in FIG. 1.

FIG. 11 is a schematic illustration for explaining circumstances in which the hemming working is executed for an edge portion of a workpiece, which includes an outer panel and an inner panel, by a hemming working device of a second exemplary embodiment of the present invention.

FIG. 12 is a flow chart showing a procedure of a hemming working method executed by the hemming working device shown in FIG. 11.

### DETAILED DESCRIPTION OF THE EXEMPLARY EMBODIMENTS

Referring to the accompanying drawings, an exemplary embodiment of the hemming working method of the present invention will be explained below in detail, wherein the explanation is made in relation to a hemming working device in which the hemming working method is executed.

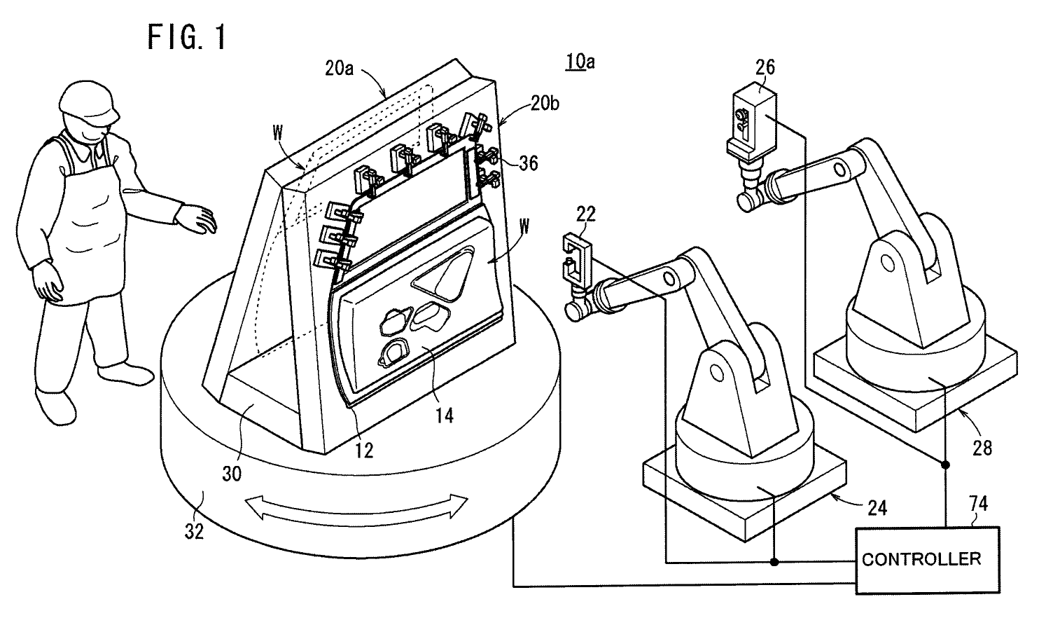

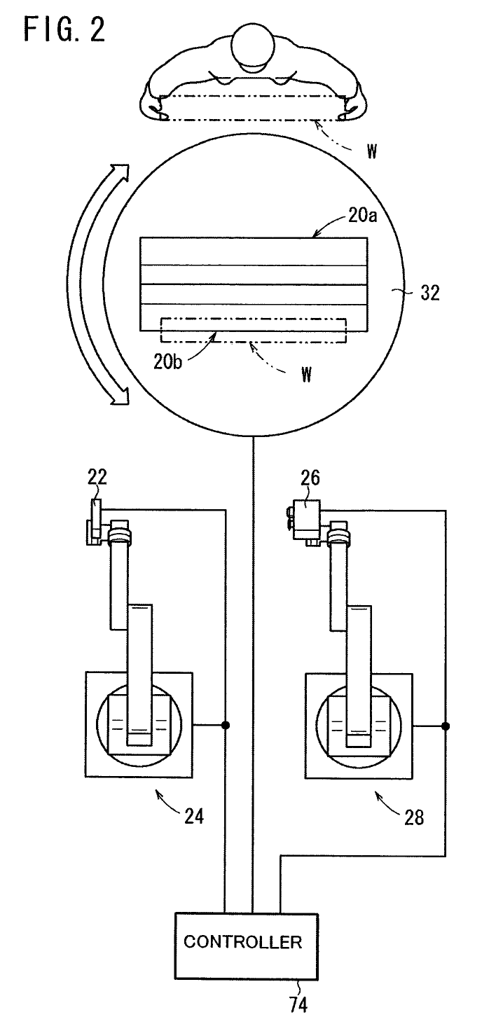

FIG. 1 is a perspective view for explaining the circumstances in which the hemming working is executed for an edge portion of workpiece W, which includes an outer panel (a first workpiece) 12 and an inner panel (a second workpiece) 14, by a hemming working device 10a of the first exemplary embodiment of the present invention. FIG. 2 is a plan view for explaining the hemming working device 10a shown in FIG. 1. In the hemming working device 10a of the present embodiment, a joining step, in which the outer panel 12 and the inner panel 14 are joined with each other by means of spot welding, and a hemming step, in which a flange portion substantially perpendicularly rising from an edge portion of the outer panel 12 is bent and an edge portion of the inner panel 14 is pinched so that both panels can be combined with each other, are simultaneously executed while keeping pace with each other.

In the present embodiment, a front door for an automobile is exemplarily shown as workpiece W to be subjected to the hemming working by the hemming working device 10a. However, it should be noted that the present invention is not limited to the above specific embodiment.

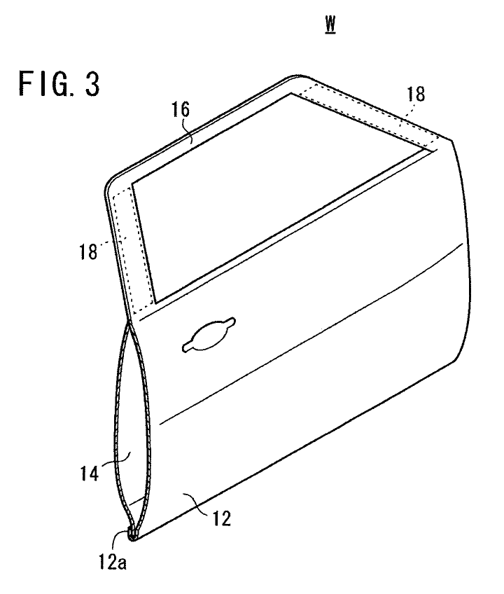

As shown in FIG. 3, in workpiece W, each portion, in which the outer panel 12 and the inner panel 14 are put on each other, is joined by means of welding and at the same time edge portions of both panels are combined with each other by the hemming working. Onto the inner panel 14 side (the vehicle compartment side) of the window frame 16 composing the outer panel 12, for example, two reinforcing members 18 for enhancing the rigidity of the window frame 16 are fixed. The outer panel 12 and the inner panel 14 are formed out of a plate material (metal) punched into a predetermined shape.

As shown in FIG. 1, the hemming working device 10a, which conducts the hemming working on workpiece W, includes: a pair of jig bodies 20a, 20b which function as a working table for holding and positioning workpiece W in the joining step and the hemming step; a first robot (working drive portion) 24, at the forward end portion of which a spot welding tool 22 is supported; and a second robot (working drive portion) 28, at the forward end portion of which a hemming working tool 26 is supported.

As shown in FIGS. 1 and 2, the pair of jig bodies 20a, 20b are fixed onto a base 30 under the condition that the upper side portions of the jig bodies 20a, 20b are connected with each other and the lower end portions are separated from each other. Due to the foregoing, the pair of jig bodies 20a, 20b are arranged being formed into a substantially triangular shape when they are viewed from the side. On a lower face of the base 30, a turn table 32 capable of freely turning is provided.

Accordingly, in the case where a worker attaches workpiece W to either the jig body 20a or 20b or in the case where the worker removes workpiece W from either the jig body 20a or 20b, the turn table 32 is turned and one of the jig bodies 20a, 20b is arranged from the working chamber side, on which the first robot 24 and others are operated, to the worker's side. Therefore, it is possible for the worker to carry in or out workpiece W without entering the working chamber. Further, since the pair of jig bodies 20a, 20b are arranged into a triangular shape being inclined with each other, the worker can more easily position and fix workpiece W with respect to the jig bodies 20a, 20b. In this connection, workpiece W may be carried in or out with respect to the jig bodies 20a, 20b by using a predetermined automatic workpiece replacing means or an auxiliary conveyance means.

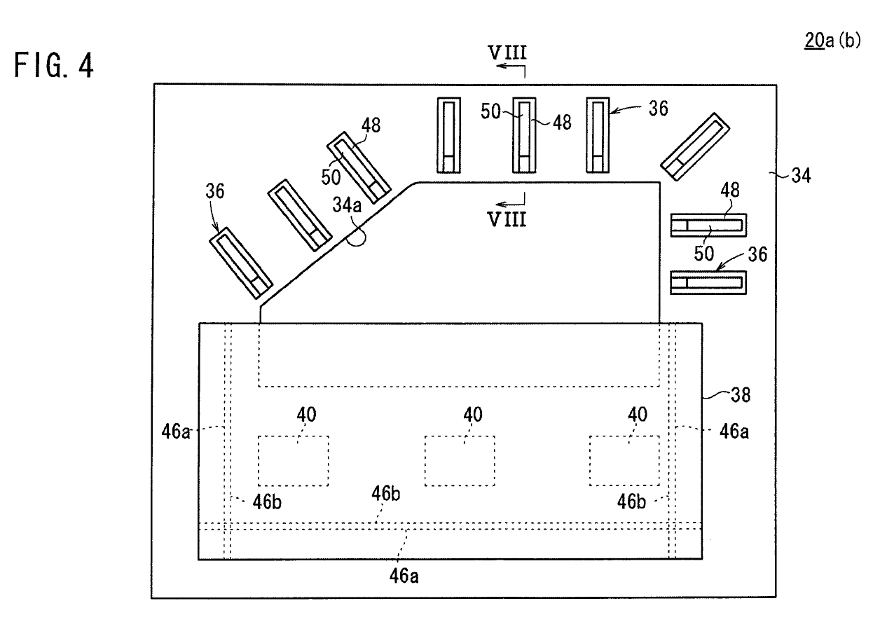

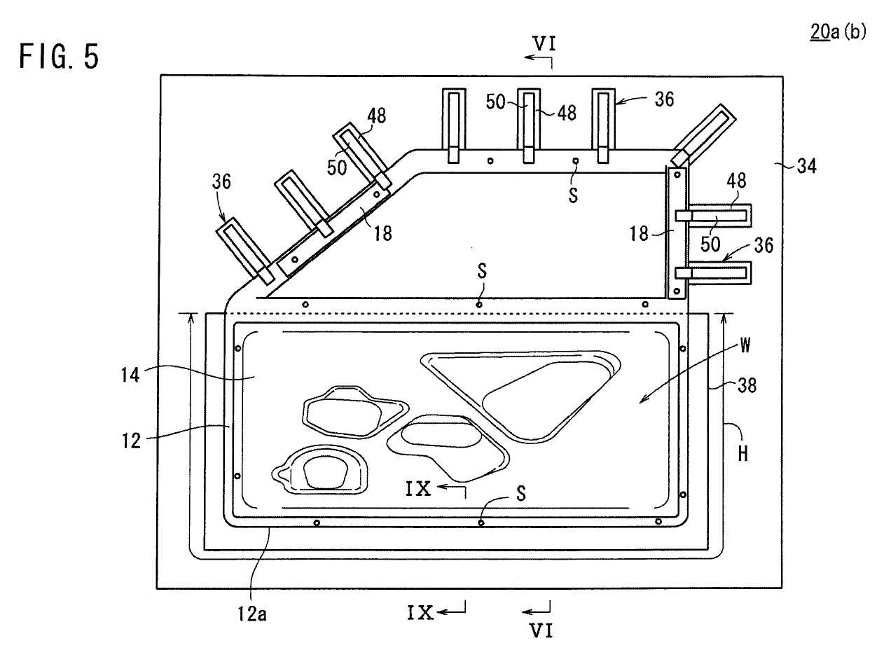

FIG. 4 is a schematic front view of the jig body 20a (20b) to which workpiece W is not fixed. FIG. 5 is a schematic front view of the jig body 20a (20b) to which workpiece W is fixed.

As shown in FIG. 4, the jig body 20a includes: a flat-plate-shaped frame 34, in the substantially central portion of which an opening portion 34a is formed; a plurality of clamp mechanisms (holding mechanisms) 36 (nine clamp mechanisms 36 in the case of the present embodiment) which are arranged on the surface side of the frame 34 in a portion from the side to the upper portion of the opening portion 34a so that the clamp mechanisms can be laid along a shape of the outer panel 12 (the window frame 16); and a backing member (a guide member, a metallic die) 38 arranged on the surface side of the frame 34 so that a substantially major lower portion of the clamp mechanism 36 can be covered.

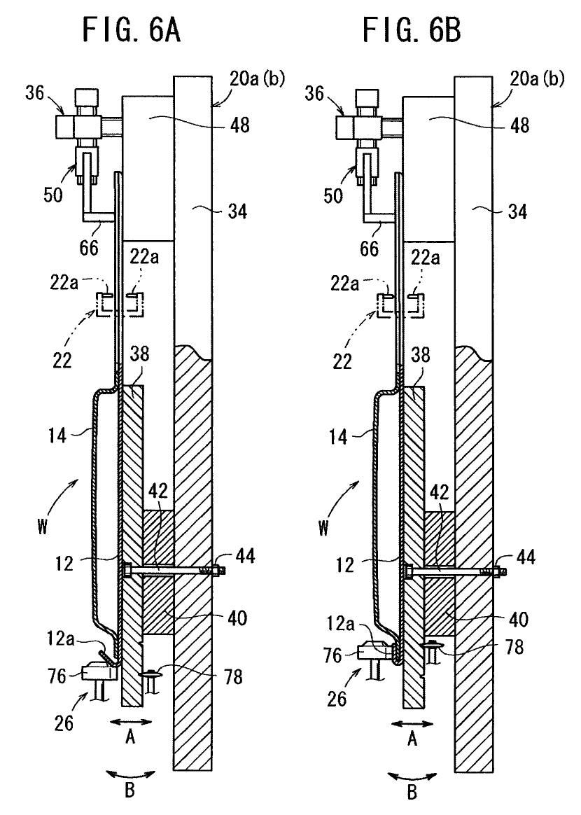

The backing member 38 is fixed at a position distant from the surface of the frame 34 by a predetermined distance through a floating supporting member 40 provided on the surface of the frame 34. Concerning this matter, refer to FIGS. 4 and 6A. In the case of the present embodiment, three floating supporting members 40 are arranged at regular intervals in the longitudinal direction (the width direction) of the backing member 38 as shown in FIG. 4. However, for example, two or four floating supporting members 40 may be arranged. Alternatively, one floating supporting member 40, which is long in the width direction, may be arranged.

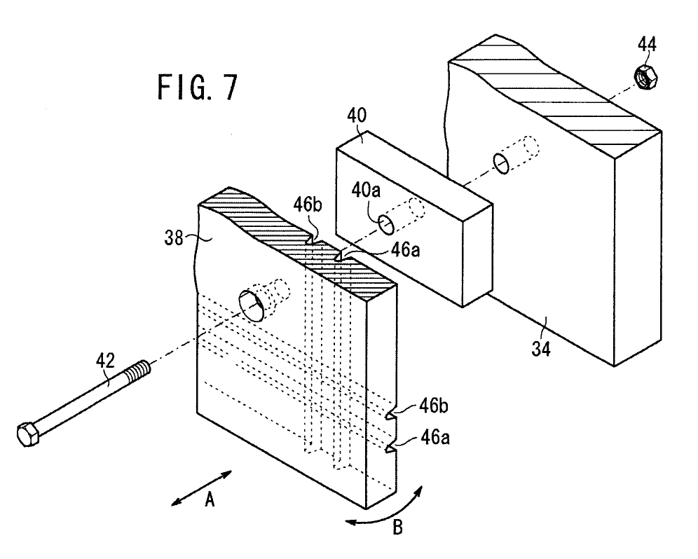

The floating supporting member 40 described above is a block made of hard rubber. As shown in FIG. 7, the floating supporting member 40 is interposed between the backing member 38 and the frame 34 and fixed by a bolt 42 and a nut 44 through an attaching hole portion 40a provided at the center. Due to the above structure, the backing member 38 is positively fixed being offset from the surface of the frame 34 by the floating supporting member 40. On the other hand, the backing member 38 is capable of floating by the elasticity of the floating supporting member 40 in the directions of arrows A and B shown in FIGS. 6A and 7.

On the back of the backing member 38 opposed to the frame 34, on the lower end side and both end sides, the first groove 46a and the second groove 46b, which are two groove portions respectively extending in the horizontal and the perpendicular direction, are formed. Concerning this matter, refer to FIGS. 4 and 7. Guide rollers composing the hemming working tool 26 are engaged with the first and the second grooves 46a, 46b. Concerning this matter, the detail will be described later.

As shown in FIGS. 4 and 5, the clamp mechanism 36 includes: a receiving portion 48, to which the outer panel 12 (the window frame 16) composing workpiece W is contacted, used for positioning workpiece W; and a movable portion 50 for holding workpiece W between the movable portion 50 and the receiving portion 48.

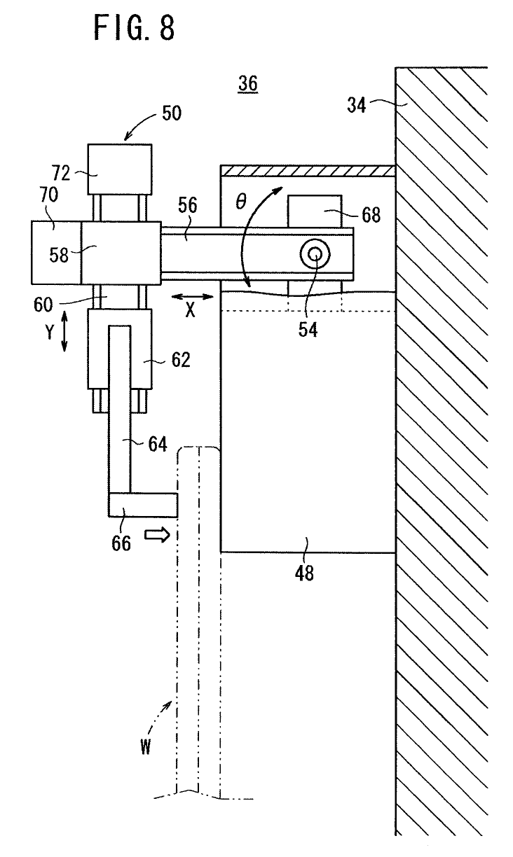

As shown in FIG. 8, the movable portion 50 includes: a first guide frame 56 pivotally supported by a rotary shaft 54 that is fixed to the receiving portion 48; a first slider member 58 movably provided in the axial direction (the direction of arrow X) of the first guide frame 56; a second guide frame 60 fixed to the first slider member 58 so that it can be perpendicular to the first guide frame 56; and a second slider member 62 movably provided so that it can be moved in the axial direction (the direction of arrow Y) of the second guide frame 60. Further, an arm member 64 is connected to the second slider member 62. Furthermore, a holding portion 66 extending in the direction of arrow X is fixed to a forward end of the arm member 64.

The first guide frame 56 can be rotated round the rotary shaft 54 by a servo motor 68 in the direction of arrow θ shown in FIG. 8. The first slider member 58, that is, the second guide frame 60 can be moved in the direction of arrow X by the servo motor 70 through a feeding screw mechanism (not shown). The second slider member 62, that is, the arm member 64 can be moved in the direction of arrow Y by the servo motor 72 through a feeding screw mechanism (not shown).

Accordingly, in the clamp mechanism 36, a position of the holding portion 66 can be adjusted in the directions of arrows X and Y. When workpiece W is interposed between the forward end face of the holding portion 66 and the receiving portion 48, workpiece W can be held (fixed) being positioned. Concerning this matter, refer to FIGS. 5 and 6A. At the time of attaching or detaching workpiece W, when the movable portion 50 (the holding portion 66) is rotated upward through the rotary shaft 54, workpiece W can be easily attached or detached.

In this connection, concerning the clamp mechanism for positioning and fixing workpiece W, except for the above clamp mechanism 36 in which workpiece W is interposed between the holding portion 66 and the receiving portion 48, for example, instead of the holding portion 66, it is possible to use a clip-shaped opening and closing means capable of holding workpiece W.

As shown in FIG. 5, the backing member 38 and the receiving member 48, which compose the jig body 20a, are composed so that the outer panel 12 can be positioned in a desired posture. Surfaces of the backing member 38 and the receiving member 48 are formed into shapes corresponding to the shape of the outer panel 12. Due to the foregoing, workpiece W can be positively and accurately positioned and fixed.

The jig body 20b, which forms a pair together with the jig body 20a, is composed in the substantial same manner as that of the jig body 20a. Therefore, the detailed explanation will be omitted here.

Referring again to FIG. 1, the first and the second robots 24, 28 are industrial articulated robots. In the first and the second robots 24, 28, the spot welding tool 22 and the hemming working tool 26 can be moved to arbitrary positions and postures being controlled by a program. Of course, the first and the second robots 24, 28 are driven being controlled so that they can not interfere with each other. Operation teaching can be conducted on the first and the second robots 24, 28 while an actual operation is being executed according to a command given by a teaching pendant not shown. Further, by off-line processing in which three-dimensional CAD (Computer Aided Design) is used, teaching of operation can be executed without actually operating the robots. The first and the second robots 24, 28 are operated being controlled by the controller 74 together with the turn table 32 and the clamp mechanism 36.

The spot welding tool 22 is, for example, a C-shaped-gun type spot welding device. In the spot welding tool 22, the outer panel 12 and the inner panel 14 are interposed between a pair of electrode chips 22a, 22a and pressurized sufficiently and then a welding current is made to flow in the electrodes. Due to the foregoing, the outer panel 12 and the inner panel 14 are joined with each other. Concerning this matter, refer to FIG. 6A.

The hemming working tool 26 includes a hemming roller (a working roller) 76 and a guide roller 78 which compose a pair of rollers. Concerning this matter, refer to FIG. 6A. When rotary shafts of the hemming roller 76 and the guide roller 78 are arranged in parallel with each other, the radial directions (the directions of the disks) of the hemming roller 76 and the guide roller 78 are arranged in parallel with each other. The hemming roller 76 and the guide roller 78 described above are composed so that they can come close with each other or they can be separated from each other.

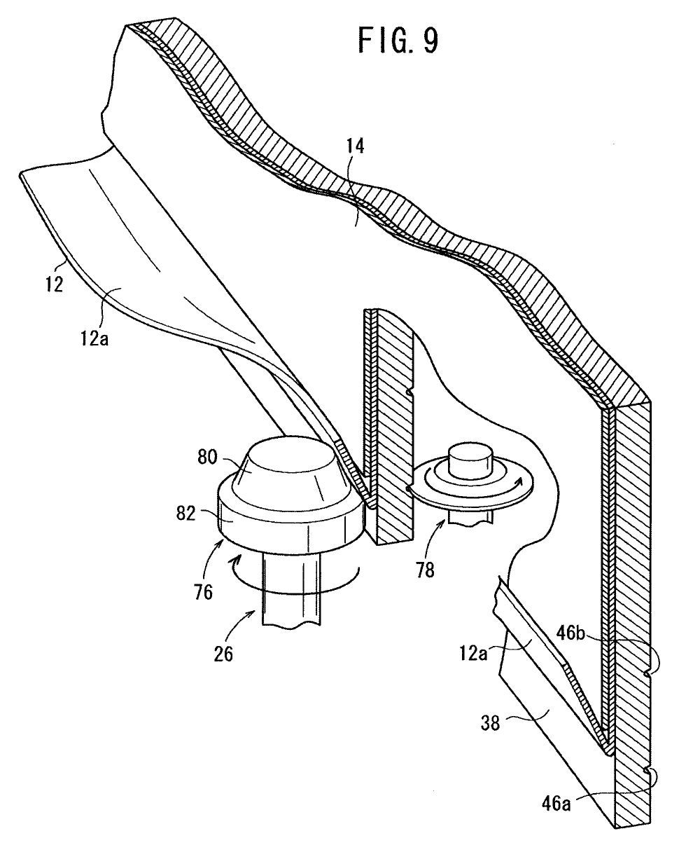

The hemming roller 76 includes: a tapered roller 80 arranged on the forward end side for executing preliminary bending of the flange 12a of the outer panel 12 (for example, executing bending of the flange 12a from a state, in which the flange 12a rises by the angle 90°, to a state in which the flange 12a rises by the angle 45°); and a cylindrical roller 82 arranged on the base end side integrally with the tapered roller 80. Concerning this matter, refer to FIG. 9. On the other hand, the guide roller 78 is formed into a disk-shape, the peripheral width of which is narrow, and capable of engaging with the first and the second grooves 46a, 46b provided in parallel with each other on the back of the frame 34 of the backing member 38. Concerning this matter, refer to FIG. 9. When the guide roller 78 is engaged with the first groove 46a or the second groove 46b, the hemming roller 76 can be accurately guided along the flange 12a.

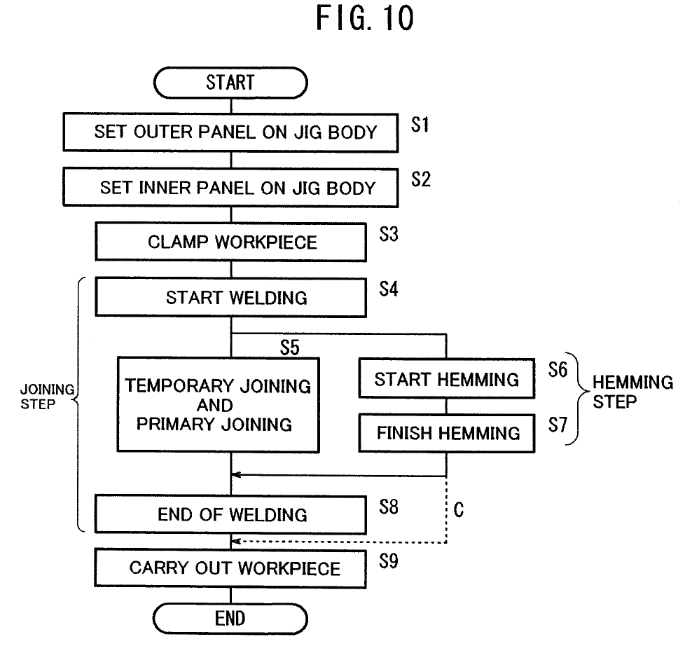

Next, referring to the flow chart of FIG. 10, explanations will be made into a hemming working method of working workpiece W by the hemming working device 10a of the present embodiment basically composed as described above.

First, in steps S1 and S2 shown in FIG. 10, a worker sets the outer panel 12 and the inner panel 14, which are workpieces W to be subjected to hemming working this time, at the jig body 20a (20b) to which workpiece W has not been fixed yet or at the jig body 20a (20b) from which workpiece W worked by the hemming working last time has already been carried out. Concerning this matter, refer to FIG. 5. At this time, a lower portion of the outer panel 12 is contacted with and positioned to the backing member 38 and an upper portion (window frame 16) is contacted with the receiving portion 48. Further, the inner panel 14 and the reinforcing member 18 are put on each other at a predetermined position.

Next, workpiece W positioned at a predetermined position is held by the clamp mechanism 36, so that workpiece W can be positively fixed at the jig body 20a (step S3). In this case, shapes of the faces of the receiving portion 48 and the backing member 38, which come into contact with workpiece W (outer panel 12), are formed into shapes corresponding to the shape of workpiece W. Therefore, it is possible to positively clamp workpiece W at a desired position in a desired posture.

After the jig body 20a of workpiece W has been positioned and fixed at the predetermined position, the turn table 32 is turned and workpiece W is arranged on the working chamber side in which the first and the second robots 24, 28 are provided. Then, the joining step and the hemming step are started by the first and the second robots 24, 28.

Being controlled by the controller 74, the spot welding tool 22, which is supported by the first robot 24, starts welding the outer panel 12 and the inner panel 14 with each other (step S4).

Successively, in step S5, joining (temporary joining) is started in which the outer panel 12 and the inner panel 14 are not perfectly fixed with each other, that is, the outer panel 12 and the inner panel 14 are allowed to somewhat move so that the occurrence of a shift can be prevented in the hemming step. Finally, strong joining (primary joining) is executed in which the outer panel 12 and the inner panel 14 can be perfectly fixed with each other. That is, in the temporary joining, some of the joining points of joining workpiece W are joined. In the primary joining, all the remaining joining points are joined. In this case, for example, assume that the number of all the joining points necessary for joining workpiece W is 30. Then, 10 points in the above 30 points are joined by the temporary joining and the remaining 20 points are joined by the primary joining.

In this connection, in the case of the present embodiment, as long as the outer panel 12 and the inner panel 14 can be positively joined with each other at joining positions, any joining positions may be used for the joining step executed by the first robot 24. For example, as shown by spot welding S in FIG. 5, the joining points are equally distributed all over the workpiece W.

On the other hand, the second robot 28 supporting the hemming working tool 26 is controlled by the controller 74 and starts operation simultaneously when joining of workpiece W is started in step S4 or alternatively the second robot 28 starts operation being a little delayed, for example, after the temporary joining has been finished. That is, simultaneously with the joining step (step S5) of workpiece W executed by the first robot 24, the hemming step is started by the second robot 28 (step S6).

In this hemming step, first of all, the hemming roller 76 and the guide roller 78 are arranged so that the outer panel 12 and the inner panel 14 can be interposed between the rollers. Then, the guide roller 78 is engaged in the first groove 46a of the backing member 38 and the tapered roller 80 composing the hemming roller 76 is contacted with the flange 12a. Concerning this matter, refer to FIG. 6A. Accordingly, as shown in FIG. 9, while the guide roller 78 is being engaged in the first groove 46a, the guide roller 78 and the tapered roller 80 are rolled. Due to the rolling of the guide roller 78 and the tapered roller 80, the preliminary bending step (the prehemming step), in which the flange 12a is bent and inclined inside by the angle 45°, is continuously carried out. At this time, while a force given between the tapered roller 80 and the guide roller 78 is being maintained at a predetermined value and further a distance between the tapered roller 80 and the guide roller 78 is also being maintained at a predetermined value, the rollers are rotated and rolled in the opposite directions. Due to the foregoing, the flange 12a can be continuously bent by a conical face of the tapered roller 80.

In this connection, in the case of the present embodiment, the portion, in which the hemming step is executed by the second robot 28, is a portion in which it is necessary to combine an edge portion of the outer panel 12 with an edge portion of the inner panel 14 by means of hemming working. For example, the portion is a range shown by arrow H in FIG. 5.

After the preliminary bending step is finished in the hemming step as described above, next, the finishing bending step (the primary hemming step) is executed. That is, the guide roller 78 is engaged in the second groove 46b of the backing member 38 and at the same time the cylindrical roller 82 is contacted with the flange 12a, which was bent by the angle 45° in the above preliminary bending step, and the flange 12a is bent until it comes into contact with the inner panel 14. Concerning this matter, refer to FIG. 6B. Due to the foregoing, the flange 12a is bent by the angle 90° from the initial angle. Accordingly, when the guide roller 78 and the cylindrical roller 82 are rolled while the guide roller 78 is being engaged in the second groove 46b, the finishing bending step (the primary hemming step) is continuously carried out in which the flange 12a is further bent and inclined by the angle 45° from the state in which the flange 12a is bent in the above preliminary bending step.

In the joining step (step S5) executed by the first robot 24, in addition to the joining points joined by the temporary joining in the hemming step executed by the second robot 28, the remaining joining points are joined. After the hemming step has been finished in step S7 and the joining step has been finished in step S8, the outer panel 12 and the inner panel 14 are strongly combined with each other by the joining made by means of welding and hemming.

In this case, the primary joining executed in step S5 may be carried out so as to join all the joining points after the completion of the hemming step (step S7). Alternatively, simultaneously with the hemming step, all the joining steps including the primary joining may be finished.

Next, after the hemming step and the joining step have been finished, the turn table 32 is turned by a half rotation being controlled by the controller 74 and workpiece W, in which the outer panel 12 and the inner panel 14 have already been combined with each other, is turned from the working chamber side to the worker's side. Then, the worker removes workpiece W, which has already been worked, from the jig body 20a (step S9). In this way, all the steps of the hemming working method of working workpiece W are finished.

In this connection, the reinforcing member 18 may be combined with the outer panel 12, for example, only by means of welding executed by the spot welding tool 22. Alternatively, the reinforcing member 18 may be combined with the outer panel 12 by means of hemming executed by the working tool 26 together with by means of welding executed by the spot welding tool 22. Alternatively, the reinforcing member 18 may be composed integrally with the inner panel 14 and the joining and the hemming working may be executed. In this connection, at the time of combining the reinforcing member 18, the clamp mechanism 36 interferes with actions of the spot welding tool 22 and the hemming working tool 26. In this case, a servo motor 68 composing the predetermined clamp mechanism 36 may be driven so as to rotate the movable portion 50 and a clamping action made by the clamp mechanism may be temporarily released.

As described above, according to the hemming working device 10a and the hemming working method of the present embodiment, the joining step and the hemming step can be executed by using the same jig body 20a (20b). Therefore, it is unnecessary to individually provide a jig and a working station for each step. Accordingly, with respect to the entire device, the space can be greatly saved and the equipment investment cost can be reduced. Further, since two steps are condensed with each other, the working efficiency can be enhanced. Furthermore, since it becomes unnecessary to execute a conveyance work of conveying workpiece W from the joining step to the hemming step, a shift and deflection of workpiece W caused by the conveyance work can be effectively prevented.

When the joining step is started before the start of the hemming step, a shift generated between the outer panel 12 and the inner panel 14 can be effectively prevented at the time of executing the hemming step. Further, in the first stage of working in the hemming step in which an amount of deflection of workpiece W is big, only a portion of workpiece W is joined by the temporary joining. Therefore, deflection of workpiece W can be effectively absorbed by the entire workpiece W and further deflection can be suppressed after the completion of working. In this case, in accordance with the advance of the hemming working and the gradual reduction of deflection of workpiece W generated by the hemming working, the joining step can be advanced.

That is, according to the present embodiment, when the hemming step is executed at the time of the joining step, in accordance with the advance of the hemming step, workpiece W can be gradually strongly joined corresponding to the circumstances. Therefore, while deflection of workpiece W in the first stage of working is being suitably absorbed, in the latter stage of working, the hemming working can be executed under the condition that workpiece W is positively fixed. Therefore, the hemming can be executed at higher quality. In the circumstances in which deflection is not generated in workpiece W, when workpiece W is positively fixed, the hemming working accuracy can be enhanced. As described above, in the present embodiment, the joining step and the hemming step are simultaneously executed. Therefore, compared with the case in which each step is individually executed, not only the cycle time is shortened but also the synergistic effects described above can be provided.

In this case, for example, in the case where preliminary bending is executed in the hemming step, when a forward portion of the hemming working tool 26 to execute the preliminary bending is acted so that the spot welding tool 22 can join workpiece W in the same direction, a shift and deflection of workpiece W generated at the time of hemming working can be effectively prevented and joining and hemming working can be more effectively executed.

In the case of the present embodiment, the backing member 38 for protecting and supporting workpiece W at the time of executing the hemming step is supported by the frame 34 through the floating supporting member 40. Due to the above structure, even if a small error is made between the surface of workpiece W (outer panel 12) and the surface of the backing member 38 coming into contact with it, workpiece W is forcibly pressed to the backing member 38 at the time of executing the hemming step. Therefore, deformation can be effectively prevented. In this connection, when the hemming working tool 26 is supported so that it can float with respect to the robot 28, deformation of workpiece W can be more effectively prevented.

In this connection, in the case of the present embodiment, concerning the timing of the finish of the hemming step (step S7) and the timing of the finish of the joining step (step S8), after the hemming step has been finished in advance, the joining step is finished as described above. Except for the timing described above, as shown by broken line C in FIG. 10, after the joining step has been finished in advance, the hemming step can be finished. In this connection, usually, the above case, in which the joining step is finished following the hemming step, is more preferable than the case in which the hemming step is finished following the joining step. That is, in the latter case, the hemming step can be finished under the condition that the outer panel 12 and the inner panel 14 are allowed to somewhat move. Therefore, deflection generated in workpiece W at the time of executing the hemming step can be more positively absorbed by the entire workpiece W. Accordingly, deflection of workpiece W can be more positively prevented after the completion of working. Of course, since the aforementioned deflection of workpiece W is seldom generated in the latter stage of working in the hemming step, depending upon the use of workpiece W, it is effective to adopt a method in which the hemming step is finished after the joining step has been finished in advance.

In this connection, an amount of deflection of workpiece W is the biggest when the hemming roller 76 holds workpiece W with pressure. Therefore, when workpiece W is not joined at this point of time or when at least a portion of workpiece W close to the rolling starting point of the hemming roller 76 is not joined, it is possible to effectively absorb deflection of the entire workpiece W. Therefore, especially when the portion of workpiece W close to the rolling starting point of the hemming roller 76 is joined after the hemming roller 76 has held workpiece W and before the hemming roller 76 starts rolling, it becomes possible to effectively prevent a shift of workpiece W while the hemming roller 76 is rolling. Accordingly, this method is preferable.

When a portion of workpiece W close to the rolling finishing point of the hemming roller 76 is not joined until rolling of the hemming roller 76 is finished, it is possible to suitably allow and absorb deflection of workpiece W that is rolling. Especially when the portion of workpiece W close to the rolling finishing point of the hemming roller 76 is joined after rolling of the hemming roller 76 has finished and before the hemming roller 76 is separated from workpiece W, that is, before holding of workpiece W by the hemming roller with pressure is released, it becomes possible to prevent the generation of spring back of workpiece W and a shift between the outer panel 12 and the inner panel 14 can be more positively prevented. Therefore, this method is preferable.

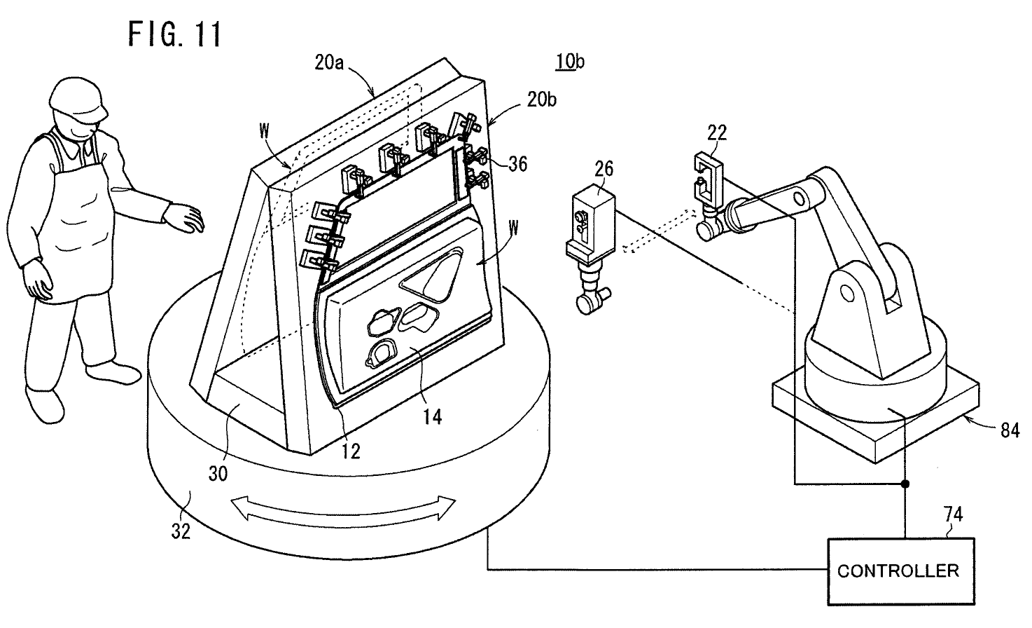

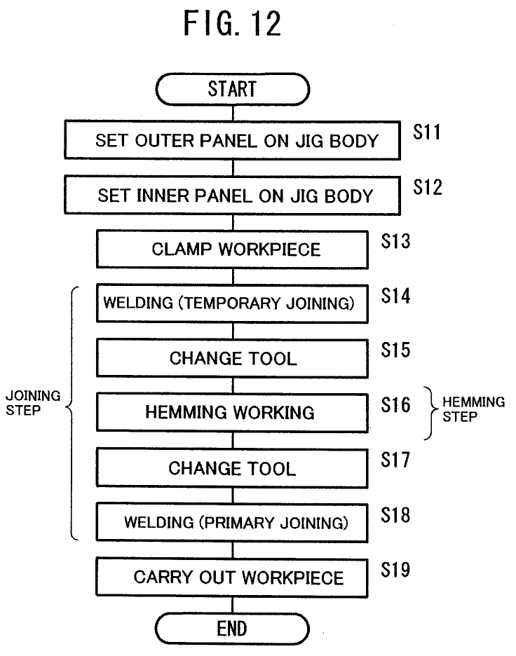

Next, referring to FIGS. 11 and 12, explanations will be made into a hemming working device 10b of the second exemplary embodiment of the present invention and a hemming working method in which this hemming working device 10b is used. In this connection, like reference marks are used to indicate like components in FIGS. 1 to 10 and in FIGS. 11 and 12. Since the same function and effect are exhibited by the components, the detailed explanations are omitted here.

The hemming working device 10b of this second exemplary embodiment includes one robot (working driving portion) 84. In this hemming working device 10b, the tool supported at the forward end portion of the arm of the robot 84 can be replaced, that is, the spot welding tool 22 and the hemming working tool 26 can be replaced with each other. Concerning this matter, refer to FIG. 11.

Next, referring to the flow chart of FIG. 12, explanations will be made into a hemming working method of working workpiece W by the hemming working device 10b of the present embodiment.

Steps S11 to S13 shown in FIG. 12 are the same as steps S1 to S3 shown in FIG. 10. Therefore, the detailed explanations are omitted here. In this connection, in the case of the present embodiment, first, the spot welding tool 22 is connected to the robot 84.

In step S14, first, the spot welding tool 22 welds and joins the outer panel 12 and the inner panel 14 being controlled by the controller 74. In this way, the joining step of the present embodiment is started.

In this connection, in this step S14, the outer panel 12 and the inner panel 14 are not completely fixed with each other, that is, the outer panel 12 and the inner panel 14 are temporarily welded with each other so that the outer panel 12 and the inner panel 14 can be allowed to somewhat move and a shift generated in the hemming step can be prevented. Therefore, some joining points among the points to be joined of workpiece W are joined.

Next, in step S15, the spot welding tool 22 supported by the robot 84 is replaced with the hemming working tool 26.

In step S16, the hemming step is executed. That is, the preliminary bending step, in which the flange 12a of the outer panel 12 is first bent by 45°, and the finishing bending step, in which the flange 12a of the outer panel 12 is further bent by 45°, are executed. At this time, workpiece W is temporarily joined being given a small amount of allowance. Therefore, it is possible to prevent a shift generated between the outer panel 12 and the inner panel 14 can be prevented at the time of executing the hemming step. Further, deflection of workpiece W can be absorbed. Therefore, the generation of deflection of workpiece W can be positively prevented.

Successively, in step S17, the hemming working tool 26 supported by the robot 84 is replaced with the welding tool 22 again.

In step S18, as the second stage of the joining step started in step S14, the outer panel 12 and the inner panel 14 are primarily joined with each other. That is, the remaining joining points, which have not been temporarily joined in step S14 described before, are welded and joined. Due to the foregoing, when step S18 is finished, that is, when the joining step is finished, the outer panel 12 and the inner panel 14 are strongly combined with each other by means of welding and hemming working.

Accordingly, the turn table 32 is turned by a half rotation being controlled by the controller 74 and workpiece W, in which the outer panel 12 and the inner panel 14 have already been combined with each other, is turned from the working chamber side to the worker's side. Therefore, the worker removes workpiece W, which has already been worked, from the jig body 20a (20b) (step S19). In this way, all the steps of the hemming working method of working workpiece W are completed.

As described above, according to the hemming working device 10b and the hemming working method of the present embodiment, the joining step and the hemming step can be executed by using the same jig body 20a (20b). Further, the joining step and the hemming step can be executed in order by using one robot 84. Therefore, compared with the hemming working device 10a of the first exemplary embodiment described above, the space can be further saved and the equipment investment cost can be reduced.

When changing of the tool shown in steps S15 and S17 is executed during the joining step shown in steps S14 to S18, it is possible to execute the hemming step shown in step S16. Due to the foregoing, it is possible to conduct hemming working on workpiece W in which a shift is prevented by the temporary joining. Accordingly, strain of workpiece W generated after the completion of the hemming working can be prevented. Further, it is unnecessary to convey workpiece W in both the joining step and the hemming step. Therefore, a shift and deflection caused during the conveyance of workpiece W can be effectively prevented.

In this connection, it should be noted that the present invention is not limited to the above specific exemplary embodiments. Variations can be made without departing from the spirit and scope of claim of the present invention.

For example, concerning the spot welding tool 22 described above, of course, it is possible to apply welding tools except for the above C-shaped-gun type welding tool. Welding tools except for the spot welding device such as a MIG welding device, a friction stirring type joining device and so forth, by which workpiece W can be joined, can be used being replaced with the spot welding device.

Concerning the hemming working tool 26 described before, except for the constitution in which the guide roller 78 is arranged in addition to the hemming roller 76, the constitution having no guide roller 78 may be employed. Of course, it is unnecessary to use the hemming roller 76 in which the taper roller 80 and the cylindrical roller 82 are integrated with each other into one body. It is possible to use a tool except for the roller, for example, it is possible to employ a metallic die hemming device in which a metallic die is used.

In each exemplary embodiment described above, two sheet members including the outer panel 12 and the inner panel 14 are used as workpiece W. However, the present invention is not limited to the above specific exemplary embodiments. It is possible to apply the present invention to a workpiece including three or more sheet members.

Concerning workpiece W of each exemplary embodiment described before, the front door for automobile use is exemplarily explained. However, the present invention is not limited to the above specific exemplary embodiments. Of course, the present invention can be applied to other portions incorporated into an automobile. Examples of workpiece W are: a rear door of an automobile, a hood, a trunk, a side panel, and a wheel arch formed in a front fender. Of course, workpiece W may be a panel used except for an automobile.

### DESCRIPTION OF THE REFERENCE NUMERALS AND SIGNS

10a, 10b Hemming working device
12 Outer panel
12a Flange
14 Inner panel
20a, 20b Jig body
22 Spot welding tool
22a Electrode chip
24, 28, 84 Robot
26 Hemming working tool
32 Turn table
34 Frame
36 Clamp mechanism
38 Backing member
40 Floating supporting member
48 Receiving portion
50 Movable portion
66 Holding portion
74 Controller
76 Hemming roller
78 Guide roller
W Workpiece

What is claimed is:

1. A hemming working method of combining at least a first workpiece with a second workpiece, comprising:
a joining step for joining the first workpiece and the second workpiece with each other; and
a hemming step for bending an edge portion of the first workpiece during the joining step so as to pinch an edge portion of the second work by the edge portion of the first workpiece.

2. The hemming working method according to claim 1, wherein the hemming step is started and finished during a period from a first joining to a last joining in the joining step.

3. The hemming working method according to claim 1, wherein after at least the first workpiece has been held by a hemming roller to execute the hemming work and before the hemming roller starts rolling, the first workpiece and the second workpiece are joined with each other.

4. The hemming working method according to claim 1, wherein after the hemming roller has finished rolling and before the hemming roller starts releasing a force given to the first workpiece and the second workpiece, the first workpiece and the second workpiece are joined with each other.

5. The hemming working method according to claim 1, wherein the first workpiece and the second workpiece are joined with each other by welding in the joining step.

6. A hemming working device comprising:
a jig body configured to support a first workpiece and a second workpiece which are overlapped; and
a working drive portion configured to join the first workpiece and the second workpiece and perform a hemming on the first workpiece and the second workpiece,
wherein the jig body includes:
a holding mechanism capable of holding the first workpiece and the second workpiece; and
a backing member capable of being contacted with a portion of the first workpiece where hemming working is executed.

7. The hemming working device according to claim 6, wherein the backing member is attached to the jig body so that it can float with respect to the jig body.

8. The hemming working device according to claim 6, wherein the working device includes a welding tool configured to join the first workpiece and the second workpiece by welding.
